(19) United States
(12) Patent Application Publication
(10) Pub. No.: US 2026/0010232 A1
(43) Pub. Date: Jan. 8, 2026

(54) WARNING SYSTEM, WARNING METHOD, AND NON-TRANSITORY COMPUTER READABLE MEDIUM FOR ENSURING SAFETY FOR A USER

(71) Applicant: CANON KABUSHIKI KAISHA, Tokyo (JP)

(72) Inventor: HIRONORI KAIDA, Kanagawa (JP)

(21) Appl. No.: 19/249,334

(22) Filed: Jun. 25, 2025

(30) Foreign Application Priority Data
Jul. 2, 2024 (JP) 2024-106720

(51) Int. Cl. G06F 3/01

(52) U.S. Cl. CPC G06F 3/016; G06F 3/011

(57) ABSTRACT

A warning system includes one or more processors configured to execute area detection processing of detecting an area of interest that is potentially unsafe for a user in a real space, execute distance determination processing of determining a distance between the user and the area of interest, and execute vibration generation processing of generating vibration that causes the user to sense a force in a direction away from the area of interest on a basis of a positional relationship between the user and the area of interest in a case where determination is made that the distance between the user and the area of interest is less than a threshold value.

### BACKGROUND

### Field of the Technology

The present disclosure relates to a warning system, a warning method, and a non-transitory computer readable medium.

### Description of the Related Art

In recent years, there is a virtual reality (VR) technology that displays an image of a virtual space as if the image is a real event. Further, there is also an augmented reality (AR) technology that displays various information overlaid on an image of a real space. Further, there is a mixed reality (MR) technology that displays a real space and a virtual space in an overlapping manner. To achieve these technologies, a head-mounted display (HMD) device has been developed as a device. In particular, in a VR-enabled HMD, visual information external to a user is blocked, so that the user can concentrate on viewing of and operation on the content, and hence high immersiveness can be obtained.

However, during viewing of VR images where external visual information is blocked, the user is at risk. For example, when the HMD is worn, the user cannot see the outside (real space). For this reason, in such a state, when the user stretches his/her hand or moves his/her body while playing a game, the user may touch a surrounding obstacle or may drop something that is on the desk.

Japanese Patent Laid-Open No. 2013-257716 proposes, in order to prevent a user wearing the HMD from touching an obstacle, an apparatus for synthesizing virtual objects at “positions in accordance with the distances to the obstacle” in a virtual space displayed on the HMD.

In Japanese Patent Laid-Open No. 2013-257716, an obstacle is displayed as a virtual object in a virtual space displayed on the HMD to induce avoidance of the obstacle. However, it is difficult for the user wearing the HMD to notice an obstacle when the visual field of the user does not include the obstacle (such as when the user moves backward and when the obstacle exists behind the user).

### SUMMARY

Accordingly, the present disclosure provides a technology for ensuring the safety for a user who cannot directly visually recognize an area that may not be safe.

The present disclosure in its one aspect provides a warning system including one or more processors configured to execute area detection processing of detecting an area of interest that is potentially unsafe for a user in a real space, execute distance determination processing of determining a distance between the user and the area of interest, and execute vibration generation processing of generating vibration that causes the user to sense a force in a direction away from the area of interest on a basis of a positional relationship between the user and the area of interest in a case where determination is made that the distance between the user and the area of interest is less than a threshold value.

The present disclosure in its one aspect provides a warning method including detecting an area of interest that is potentially unsafe for a user in a real space, determining a distance between the user and the area of interest, and generating vibration that causes the user to sense a force in a direction away from the area of interest on a basis of a positional relationship between the user and the area of interest in a case where determination is made that the distance between the user and the area of interest is less than a threshold value.

Features of the present disclosure will become apparent from the following description of embodiments with reference to the attached drawings. The following description of embodiments is described by way of example.

### BRIEF DESCRIPTION OF THE DRAWINGS

FIG. 1 is a block view of a warning system according to one or more aspects of the present disclosure.

FIG. 2 is a cross-sectional view of an HMD according to one or more aspects of the present disclosure.

FIG. 3 is a view illustrating a line-of-sight detection method according to one or more aspects of the present disclosure.

FIGS. 4A and 4B are views illustrating the line-of-sight detection method according to one or more aspects of the present disclosure.

FIG. 5 is a flowchart of a sight line detection operation according to one or more aspects of the present disclosure.

FIGS. 6A, 6B, and 6C are each a view for illustrating a vibration pattern of illusionary tactile force sense according to one or more aspects of the present disclosure.

FIG. 7 is a flowchart of overall processing for obstacle avoidance according to one or more aspects of the present disclosure.

FIGS. 8A and 8B are each a view illustrating the detection of the motion using a sensor according to one or more aspects of the present disclosure.

### DESCRIPTION OF THE EMBODIMENTS

### Embodiment 1

Embodiment 1 will be described in details with reference to the accompanying drawings. Incidentally, in Embodiment 1, a warning system having an information processing device will be described. Further, an HMD (head-mounted display), which is a head-mounted display device, will be described as an example of the information processing device.

In Embodiment 1, the HMD has a warning unit that warns a user of contact (collision) with an obstacle in a non-transmission mode in which images of the virtual space can be viewed. On the other hand, the technology described in Embodiment 1 is also applicable to the transmission modes relating to AR or MR that projects an image of a virtual space into a real space. Here, “the transmission mode” is a mode in which a user can directly or indirectly view the real space. The “non-transmission mode” is the mode in which the user is not able to view the real space in any manner of directly and indirectly. Hereinafter, a description will be given to an HMD capable of switching between the transmission mode and the non-transmission mode.

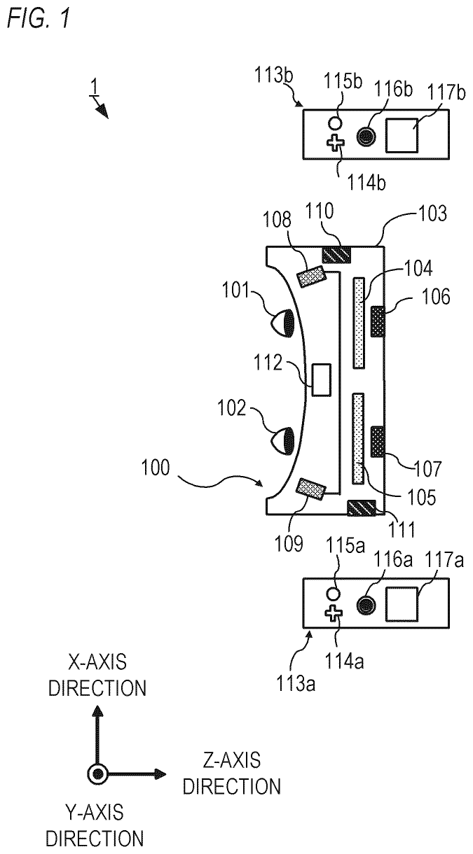

The configuration of a warning system 1 according to Embodiment 1 will be described with reference to FIG. 1. The warning system 1 has an HMD 100, a controller 113a, and a controller 113b. FIG. 1 shows a configuration of the HMD 100 as viewed from the head top side of a user (Y-axis direction).

### Configuration of HMD

The HMD 100 has a housing 103, a left-eye display 104, a right-eye display 105, a left-eye camera 106, a right-eye camera 107, a left-eye line-of-sight detector 108, a right-eye line-of-sight detector 109, an inertial sensor 110, an illusionary tactile force sense unit 111, and a communication unit 112.

The housing 103 fixes (holds) each member of the HMD 100.

The left-eye display 104 displays an image to be seen by the user's left eyeball 101. When the HMD 100 is in the transmission mode, the left eyeball 101 can observe the real space through the left-eye display 104 when the housing 103 of the HMD 100 is mounted on the head.

The right-eye display 105 displays an image to be seen by the user's right eyeball 102. When the HMD 100 is in the transmission mode, the right eyeball 102 can observe the real space through the right-eye display 105 when the housing 103 of the HMD 100 is mounted on the head. In the transmission mode, when an image such as an operation icon is displayed on each display, the user can view the real space and the operation icon through the display.

The left-eye camera 106 images a real space. An image resulting from photographing of the real space by the left-eye camera 106 is displayed on the left-eye display 104 in the transmission mode.

The right-eye camera 107 images a real space. An image resulting from photographing of the real space by the right-eye camera 107 is displayed on the right-eye display 105 in the transmission mode.

The left-eye line-of-sight detector 108 can detect the direction of the user's line of sight of the left eyeball 101 of the user and the position (viewpoint position) where the user's left eyeball 101 is seeing. The right-eye line-of-sight detector 109 can detect the direction of the line of sight of the right eyeball 102 of the user and the position (viewpoint position) that is being looked at by the user's right eyeball 102.

The inertial sensor 110 has an acceleration sensor for detecting the translational movement of the HMD 100 for each of the XYZ axes. Furthermore, the inertial sensor 110 has a gyrosensor that detects the rotational movement of the HMD 100 on each of YPR (yaw, pitch, and roll) axes. The inertial sensor 110 can comprehensively detect the translational movement and the rotational movements of the HMD 100 by associating the two sensors.

The illusionary tactile force sense unit (vibration generating unit) 111 is a haptics device that achieves a haptics technology (illusionary tactile force sense technology). The illusionary tactile force sense unit 111 includes an acceleration sensor, a position sensor, and an eccentric motor. The illusionary tactile force sense unit 111 acquires information on acceleration and position information of a body segment in contact, and generates various vibrations by the eccentric motor according to the acquired information. As a result of this, the illusionary tactile force sense unit 111 makes a user feel a sense of being pressed or pulled.

The illusionary tactile force sense unit 111 uses the vibration pattern using the haptics effect, and thereby can give a user a sensory warning (instruction) about obstacle avoidance. The illusionary tactile force sense unit 111 may be mounted (installed) on not a circuit provided on only the HMD 100 but also on a controller 113a or a controller 113b. Further, a plurality of motion sensors provided with the illusionary tactile force sense unit 111 may be independently mounted (installed) in the vicinity of each joint segment of the user's body. As a result of this, the motion sensor estimates a three-dimensional orientation, thereby estimating the motions including a user's orientation, and generates fine illusionary tactile force sense vibration for each mounted segment. By doing so, the illusionary tactile force sense unit 111 can generate a tensile tension in a more appropriate direction.

The communication unit 112 transmits and receives information to and from an external communication device. The HMD 100 can exchange information with equipment paired with the HMD 100 (such as controllers 113a and 113b) via the communication unit 112.

### Configuration of Controller

The controller 113a and the controller 113b are controllers for controlling game images, images of the virtual space, or the like. The controller 113a is a controller to be held by the right hand of the user. The controller 113b is a controller to be held by the left hand of the user. Since the controller 113a and the controller 113b have similar configurations, only the configuration of the controller 113a will be described below.

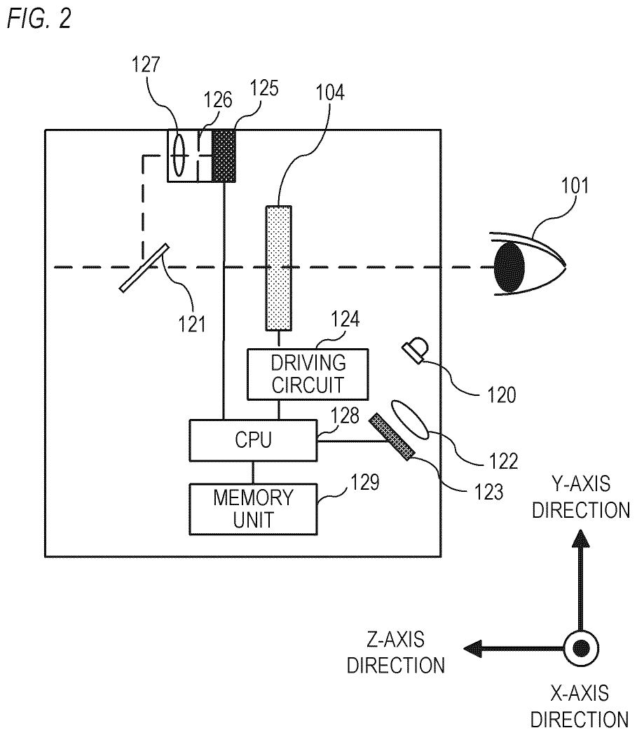

The controller 113a has a plurality of operating members such as a cross key 114a, a button 115a, a lever 116a, and a touch panel 117a. A user can control, for example, the images displayed on the left-eye display 104 and the right-eye display 105 by performing the operation on each operating member. The operation on the controller 113a is transmitted to the CPU 128 (see FIG. 2) as an operation signal.

FIG. 2 is a cross-sectional view of the HMD 100 cut into left and right halves by the YZ plane formed by the Y-axis and the Z-axis shown in FIG. 1. FIG. 2 shows a schematic view of a mechanism for detecting the line of sight. Incidentally, FIG. 2 is a cross-sectional view viewed from the left-eye side, and the mechanism on the left eye side will be described below. Incidentally, the mechanism on the right eye side is the same mechanism as the mechanism on the left eye side.

The HMD 100 has a left-eye display 104, an illumination light source 120, a light splitter 121, a light receiving lens 122, and an eye photographing element 123. The HMD 100 has a display drive circuit 124, a camera photographing element 125, an aperture mechanism 126, a focus mechanism 127, a CPU 128 and a memory unit 129. Incidentally, the CPU 128 and the memory unit 129 are common to at least the left eye side mechanism and the right-eye-side mechanism.

The illumination light source 120 is a light source that projects light onto the left eyeball 101 for line-of-sight detection. The illumination light source 120 has, for example, a plurality of infrared light emitting diodes.

The light splitter 121 splits light from the real space into reflected light and transmitted light.

The light receiving lens 122 forms the illuminated eyeball image and the image resulting from the cornea reflection of the light source on the eye photographing element 123. The light receiving lens 122 positions the pupil of the left eyeball 101 of the user and the eye photographing element 123 in a complementary imaging relationship.

In the eye photographing element 123, a row of photoelectric elements such as CMOS are two-dimensionally arranged. The direction of the line of sight can be detected by using a predetermined algorithm described later on the basis of the positional relationship between the eyeball imaged on the eye photographing element 123 and the image resulting from the corneal reflection of the illumination light source 120.

Incidentally, the illumination light source 120, the light receiving lens 122, and the eye photographing element 123 constitute the left-eye line-of-sight detector 108.

The camera photographing element 125, the aperture mechanism 126, and the focus mechanism 127 are each a mechanism constituting the left-eye camera 106 which photographs the outside (real space) during the transmission mode. The left-eye camera 106 can photograph an object through the light splitter 121.

The CPU 128 controls the entire HMD 100.

The memory unit 129 stores photographing signals from the camera photographing element 125 and the eye photographing element 123. The memory unit 129 stores the line-of-sight correction data.

### Description of Line-of-Sight Detection Operation

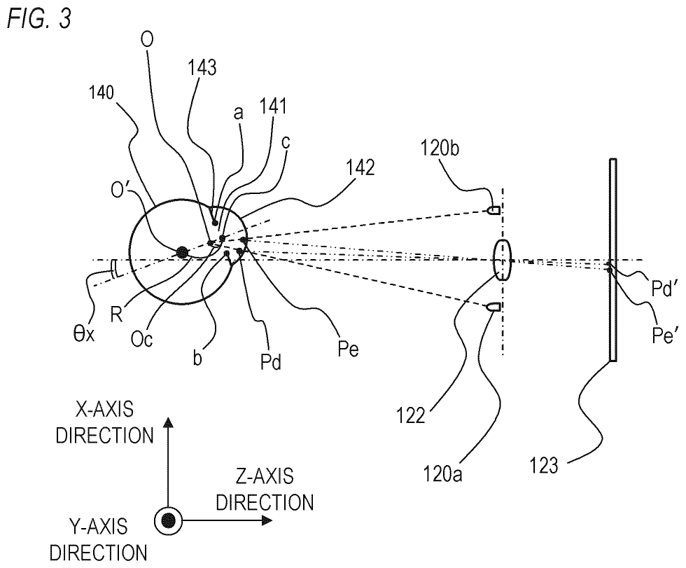

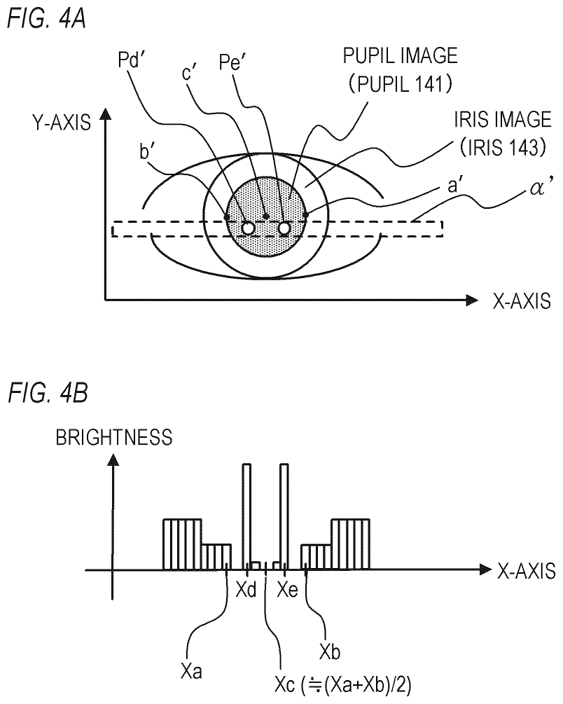

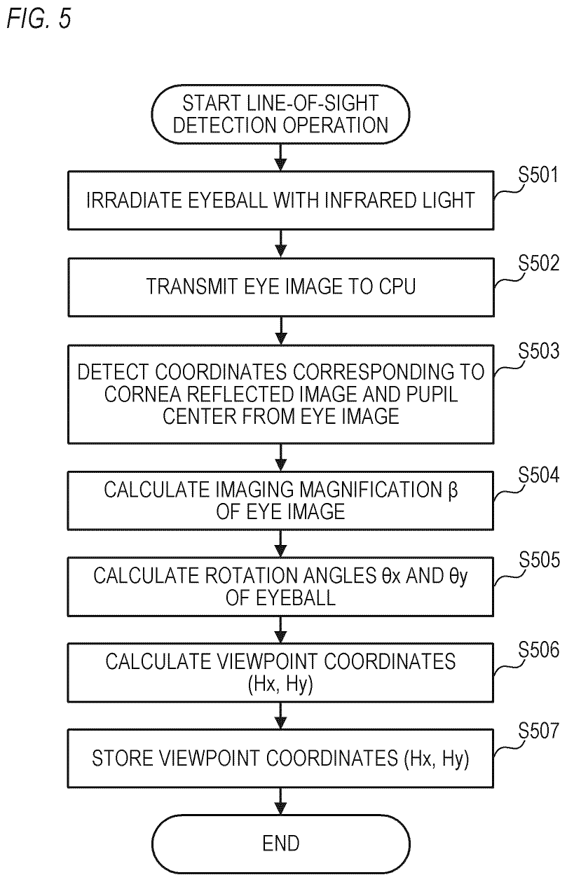

A line-of-sight detection method will be described with reference to FIGS. 3, 4A, 4B, and 5. FIG. 3 is a view for illustrating the principle of the line-of-sight detection method, and is a schematic view of an optical system for performing line-of-sight detection. As shown in FIG. 3, the illumination light source 120 (light sources 120a and 120b) is arranged substantially symmetrically with respect to the optical axis of the light receiving lens 122 to illuminate the user's eyeball 140. A part of the light emitted from the light sources 120a and 120b and reflected by the eyeball 140 is condensed on the eye photographing element 123 by the light receiving lens 122. FIG. 4A is a schematic view of an eye image (an eyeball image projected onto the eye photographing element 123) captured by the eye photographing element 123, and FIG. 4B is a view showing the output intensity of the CCD in the eye photographing element 123. FIG. 5 shows a schematic flowchart of a line-of-sight detection operation.

When the line-of-sight detection operation starts, in a step S501 in FIG. 5, the light sources 120a and 120b emit infrared light toward the user's eyeball 140. The eyeball image of the user illuminated by the infrared light is formed on the eye photographing element 123 through the light receiving lens 122 and is photoelectrically converted by the eye photographing element 123. This results in an electrical signal of the processable eye image.

In a step S502, the line-of-sight detection circuit 201 sends an eye image (an eye image signal; an electrical signal of the eye image) obtained from the eye photographing element 123 to the CPU 128.

In a step S503, the CPU 128 determines the coordinates of points corresponding to the cornea reflected images Pd and Pe of the light sources 120a and 120b and the pupil center c from the eye image obtained in the step S502.

The infrared light emitted from the light sources 120a and 120b illuminates the cornea 142 of the user's eyeball 140. At this time, the cornea reflected images Pd and Pe formed by a part of the infrared light reflected on the surface of the cornea 142 are condensed by the light receiving lens 122 and formed on the eye photographing element 123, resulting in the cornea reflected images Pd′ and Pe′ in the eye image. Similarly, the light beams from the ends a and b of the pupil 141 are also imaged on the eye photographing element 123, resulting in pupil end images a′ and b′ in the eye image.

FIG. 4B shows the brightness information (brightness distribution) of the area a′ in the eye image of FIG. 4A. FIG. 4B shows the brightness distribution in the X-axis direction with the horizontal direction of the eye image being the X-axis direction, and the vertical direction being the Y-axis direction. In Embodiment 1, the coordinates of the cornea reflected images Pd′ and Pe′ in the X-axis direction (horizontal direction) are assumed to be Xd and Xe, respectively, and the coordinates in the X-axis direction of the pupil end images a′ and b′ are assumed to be Xa and Xb, respectively. As shown in FIG. 4B, the coordinates Xd and Xe of the cornea reflected images Pd′ and Pe′ provide an extremely high level of brightness. In an area from the coordinate Xa to the coordinate Xb corresponding to the area of the pupil 141 (the area of the pupil image obtained by imaging the light beams from the pupil 141 on the eye photographing element 123), an extremely low level of brightness is obtained except for the coordinates Xd and Xe. Then, in the area of the iris 143 outside the pupil 141 (the area of the iris image outside the pupil image obtained by imaging the light beams from the iris 143), the intermediate brightness between the two kinds of brightnesses is obtained. Specifically, the intermediate brightness between the two types of brightnesses is obtained in the area where the X-coordinate (coordinate in the X-axis direction) is smaller than the coordinate Xa and the area where the X-coordinate is larger than the coordinate Xb.

From the brightness distribution as shown in FIG. 4B, the X-coordinates Xd and Xe of the cornea reflected images Pd′ and Pe′ and X-coordinates Xa and Xb of the pupil end images a′ and b′ can be obtained. Specifically, the coordinates with extremely high brightness can be obtained as the coordinates of the cornea reflected images Pd′ and Pe′, and the coordinates with extremely low brightness can be obtained as the coordinates of the pupil end images a′ and b′. Further, when the angle of rotation Ox of the optical axis of the eyeball 140 with respect to the optical axis of the light receiving lens 122 is small, the coordinate Xc of the pupil center image c′ (the center of the pupil image) obtained by imaging the light beams from the pupil center c on the eye photographing element 123 can be expressed as Xc≈(Xa+Xb)/2. That is, the coordinate Xc of the pupil center image c′ can be calculated from the respective X-coordinates Xa and Xb of the pupil end images a′ and b′. In this way, the coordinates of the cornea reflected images Pd′ and Pe′, and the coordinate of the pupil center image c′ can be estimated.

In a step S504, the CPU 128 calculates an imaging magnification β of the eyeball image. The imaging magnification β is a magnification determined by the position of the eyeball 140 with respect to the light receiving lens 122, and can be determined using the function of the spacing (Xd-Xe) between the cornea reflected images Pd′ and Pe′.

In a step S505, the CPU 128 calculates the rotation angle of the optical axis of the eyeball 140 with respect to the optical axis of the light receiving lens 122. The X-coordinate of the middle point between the cornea reflected image Pd and the cornea reflected image Pe and the X-coordinate of the curvature center O of the cornea 142 almost match. For this reason, when the standard distance from the curvature center O of the cornea 142 to the center c of the pupil 141 is assumed to be Oc, the angle of rotation θx of the eyeball 140 within the Z-X plane (plane perpendicular to the Y-axis) can be calculated by the following expression 1. The angle of rotation θy of the eyeball 140 in the Z-Y plane (plane perpendicular to the X-axis) can also be calculated in the same manner as the method of calculating the angle of rotation θx.

$$β \times Oc \times SIN θ x \approx \{ ( Xd + Xe ) / 2 \} - Xc \qquad ( Expression 1 )$$

In a step S506, the CPU 128 determines (estimates) the user's viewpoint position (the position where the user's line of sight is focused; the position that is being looked at by the user) in the visual recognition image displayed on a display unit (such as a left-eye display 104) using the calculated rotation angles θx and θy. Assuming that the coordinates (Hx, Hy) of the viewpoint position are the coordinates corresponding to the pupil center c, the coordinates (Hx, Hy) of the viewpoint position can be calculated by the following expressions 2 and 3.

$$Hx = m \times ( Ax \times θ x + Bx ) \qquad ( Expression 2 )$$

$$Hy = m \times ( Ay \times θ y + By ) \qquad ( Expression 3 )$$

The parameter m in the expressions 2 and 3 is a constant determined by the configuration of the finder optical system (such as the light receiving lens 122), and is a conversion coefficient for converting the rotation angles θx and θy into coordinates corresponding to the pupil center c in the visual recognition image. The parameter m is assumed to be determined in advance and to be stored in a memory unit 129. The parameters Ax, Bx, Ay, and By are line-of-sight correction parameters for correcting individual differences in line of sight, and is assumed to be acquired by performing a calibration operation and to be stored in the memory unit 129 before starting the line-of-sight detection operation.

In a step S507, the CPU 128 stores the coordinates (Hx, Hy) of the viewpoint position in the memory unit 129, and terminates the line-of-sight detection operation. The direction of the line of sight is the direction from the user's eyeball to the viewpoint position, and hence can be calculated on the basis of the coordinates of the user's eye and the coordinates of the viewpoint position.

In the above description, the method for acquiring the coordinates of the viewpoint position (fixation point) on the display unit using the cornea reflected image of the light sources 120a and 120b has been described. Not limited to this, any method may be used to acquire the coordinates of the viewpoint position (the angle of rotation of the eyeball) from the captured eyeball image.

### Description of the Overall Processing

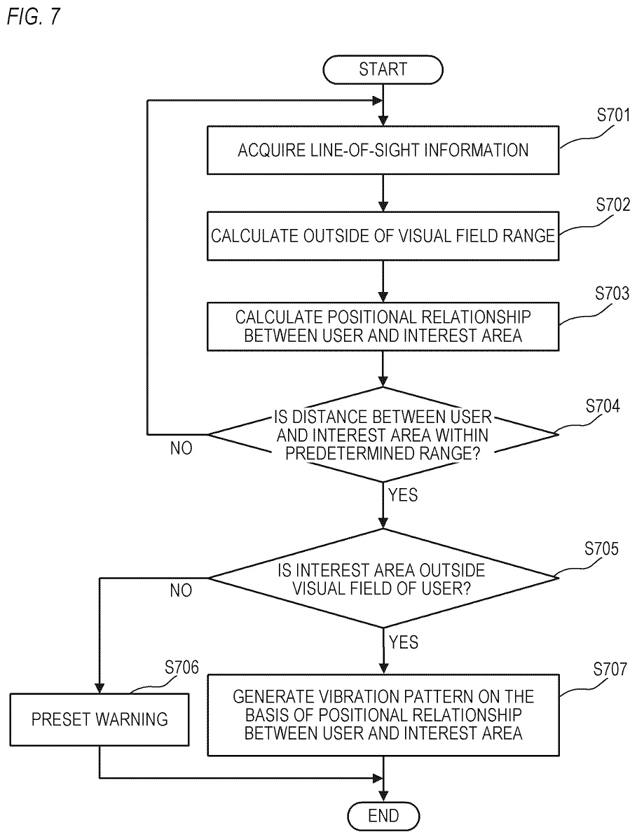

The overall processing of the warning system 1 for obstacle avoidance according to Embodiment 1 will be described with reference to the flowchart in FIG. 7. Incidentally, the following processing is realized by control of each unit by the CPU 128 in accordance with a program stored in the memory unit 129. The processing in the flowchart of FIG. 7 starts in “a state where the power source of the HMD 100 is turned on, the CPU 128 performs image processing, and the images of the virtual space or the like are displayed on the left-eye display 104 and the right-eye display 105”.

In a step S701, the CPU 128 controls the left-eye line-of-sight detector 108 and the right-eye line-of-sight detector 109 to acquire information (line-of-sight information) in the line-of-sight direction of the user.

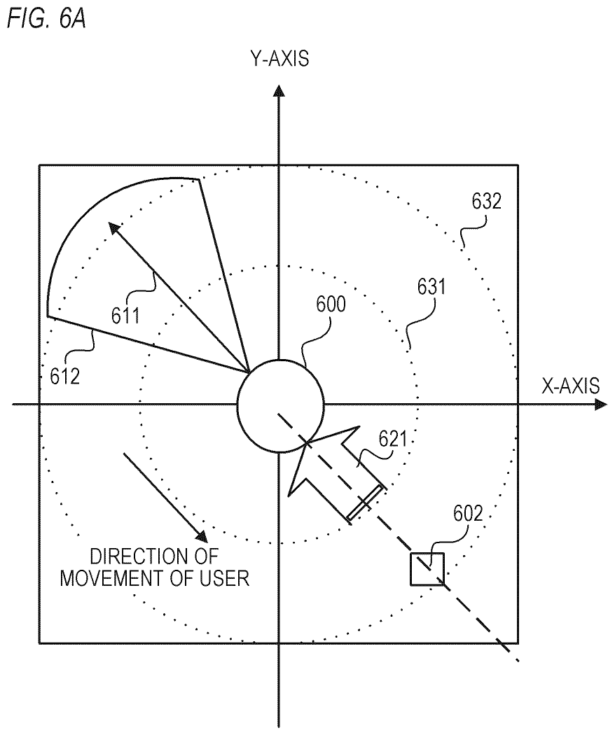

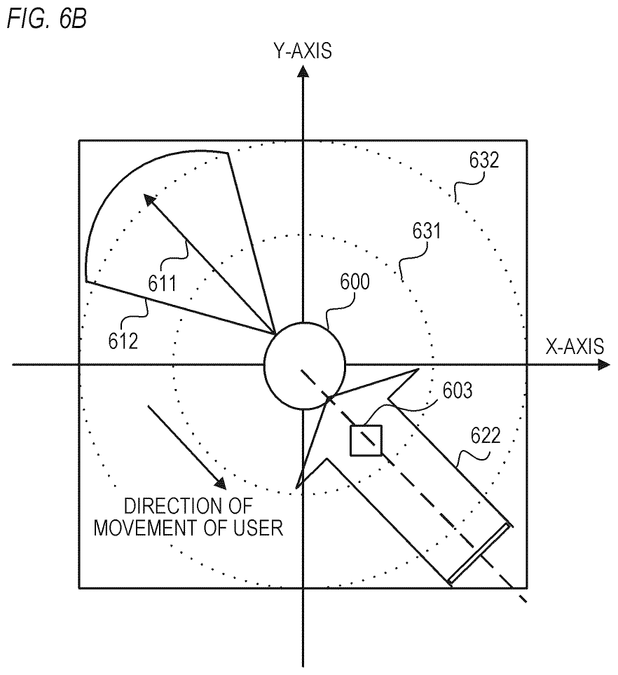

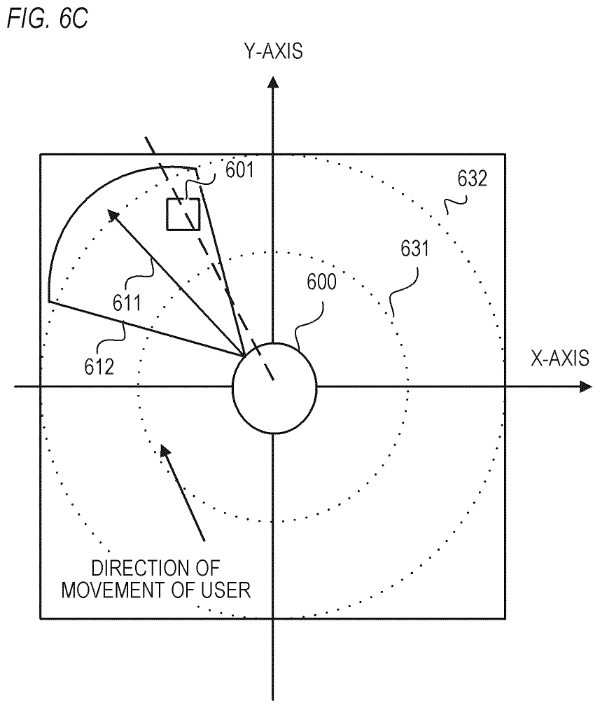

In a step S702, the CPU 128 calculates the outside of the visual field range of the user on the basis of the information on the line-of-sight direction of the user. The “visual field range of the user” is, for example, the range of the “central visual field of the user” when the user does not wear the HMD 100. Incidentally, the “visual field range of the user” may be “a range including the central visual field and the peripheral visual field of the user” when the user does not wear the HMD 100. Since the human center field of view has individual differences, it is important to previously calculate the range of the center field of view of the user using the HMD 100 in the case of accurately calculating the outside of the visual field range. Also, the CPU 128 may set, for example, a range that extends within a predetermined angular range (e.g., within 35 degrees) as the central visual field (e.g., visual field range 612 in FIG. 6A) with a user's line of sight direction (e.g., a line of sight direction 611 in FIG. 6A) as a center (reference). Then, the CPU 128 may calculate, for example, the area outside the central visual field as outside the visual field range.

In a step S703, the CPU 128 detects “the area including an obstacle that needs to undergo obstacle avoidance” as an “area of interest”, and then calculates (detects) the positional relationship between the area of interest and the user (the distance between the area of interest and the user). For example, the obstacle can be another player (person) who is experiencing a virtual space (virtual reality space) simultaneously with the user within a guardian (the user's movable range) set by the user. Also, the obstacle can be a moving object, such as a ball, that has entered the inside of a guardian. In other words, the obstacle may be any object that may be in contact with a user (e.g., an object in a guardian, or an object within a specific distance from the user, such as a distance from the user of within 1 m or within 2 m). In addition to such objects (moving objects), for example, the area of interest may include, as an obstacle, “objects that are difficult to remove before experience of a virtual space and must be present in a guardian (such as a pre-configured large desk or table)”. The area of interest may include a “non-movable area that is an area outside the guardian”. For this reason, the area of interest may not be limited to the area that may come in contact with an obstacle, but may be any area that may not be safe (may be dangerous) (e.g., an area of a slippery floor or an area where steps occur). Incidentally, in the following description, a description will be given assuming that one obstacle area is an area of interest. Further, the distance between the user and the area of interest may be the distance between the head (=HMD 100) of the user and the central part of the area of interest, or may be the distance between the hand or foot of the user and the outer peripheral part of the area of interest.

In a step S704, the CPU 128 determines whether or not the distance between the user and the area of interest determined in the step S703 is within a predetermined range (less than a predetermined threshold value). When the distance between the user and the area of interest is long and it is determined that the distance is outside the predetermined range (equal to or more than a predetermined threshold value), it is determined that there is no need to perform obstacle avoidance, and the process returns to the step S701. When it is determined that the distance between the user and the area of interest is within a predetermined range (less than a predetermined threshold value), the process proceeds to a step S705.

In the step S705, the CPU 128 determines whether or not the area of interest is located (included) outside the visual field range of the user wearing the HMD 100. When it is determined that the area of interest is located (included) within the visual field range of the user, the process proceeds to a step S706. When it is determined that the area of interest is located outside the visual field range of the user, the process proceeds to step a S707.

In a step S706, the CPU 128 prompts the user to avoid an obstacle by performing preset warning (notification of risk of contact with the obstacle). For example, the CPU 128 displays a virtual object indicating an obstacle in an image of the virtual space displayed on the HMD 100. A user wearing the HMD 100 cannot directly visually recognize the actual obstacle in the non-transmittance mode. However, when the virtual object is projected (arranged) at a position in the virtual space corresponding to the position of the actual obstacle (area of interest), the user can indirectly visually recognize the obstacle. For this reason, a user can avoid an obstacle. Also, since no actual obstacle is displayed during the display of the virtual space, it is also possible to prevent a decrease in the immersiveness of the virtual space experience (virtual reality experience).

In the step S707, the CPU 128 controls the illusionary tactile force sense unit 111 to generate a vibration pattern (a vibration pattern for making illusionary tactile force sense perceived) on the basis of the positional relationship between the user and the area of interest. In Embodiment 1, the illusionary tactile force sense unit 111 generates vibration on the basis of “the direction in which the area of interest exists with reference to the position of a user” and “the distance from the user to the area of interest”. As a result of this, the CPU 128 performs a warning indicating that there is a risk that the user and the obstacle are in contact with each other.

Specifically, in the step S707, the illusionary tactile force sense unit 111 generates a vibration pattern and vibrates in the generated vibration pattern. As a result of this, the illusionary tactile force sense unit 111 notifies the user of the position of the obstacle in the real space. The vibration pattern generated by the illusionary tactile force sense unit 111 is a vibration pattern that can give the user a response feeling of the object or a feeling of touching the object by stimulating the skin of the user with a specific pattern of vibration.

In Embodiment 1, the illusionary tactile force sense unit 111 is mounted (installed) on the HMD 100. The motion of the head of the user wearing the HMD 100 is sensed by a position sensor or an acceleration sensor. The illusionary tactile force sense unit 111 changes the acceleration pattern of the eccentric motor according to the information on the position, the speed, or the acceleration obtained by the sensor. As a result of this, the illusionary tactile force sense unit 111 can give the illusionary tactile force sense to the user. The illusionary tactile force sense unit 111 can express a “sense of force” such as sensation of being pulled or being pushed, a “sense of pressure” such as sensation of being soft/hard, and a “sense of touch” which is a surface material feeling of an object by changing the vibration pattern.

In Embodiment 1, the illusionary tactile force sense unit 111 causes the user to feel a pulling or pressing force (force having a component of direction and strength) in accordance with the positional relationship between the user and the obstacle. As a result of this, even a user who wears the HMD 100 and cannot visually recognize an actual obstacle, can sensuously (intuitively) identify the position of the obstacle.

In this way, the CPU 128 operates as “an area detection unit that detects the area of interest that is an area which may be unsafe for the user (such as an area including an obstacle that may come in contact with the user) in the real space”. Also, the CPU 128 operates as “a determination unit that determines whether or not the area of interest is included in the visual field range of the user”. The CPU 128 also operates as “a distance determination unit that determines the distance between the user and the area of interest”. However, the warning system 1 may have, separately from the CPU 128, an area detection unit, a determination unit, and a distance determination unit. Hereinafter, the difference in the vibration pattern of the illusionary tactile force sense generated according to the positional relationship between the user and the obstacle will be described with reference to FIGS. 6A to 6C. FIGS. 6A, 6B, and 6C respectively show the vibration patterns of the illusionary tactile force sense when the positional relationship between a user 600 wearing the HMD 100 and the obstacle is different. The line-of-sight direction 611 indicates the line-of-sight direction of the user 600 wearing the HMD 100, and a visual field range 612 indicates the range of the central visual field that the user 600 can see when the HMD 100 is not worn. Further, vector 621 and vector 622 express the magnitude and the direction of the pulling (or pressing) force of the illusionary tactile force sense to be perceived by the user 600. The vector 621 and the vector 622 indicate that a larger norm generates vibrations that are capable of perception of a stronger pulling force. Also, the range 631 and the range 632 indicate the ranges according to the distance from the user 600 to the obstacle.

FIG. 6A shows the state in which the user 600 has moved backward and has approached an obstacle 602 outside the visual field range 612. The obstacle 602 has been determined to be located outside the visual field range 612 of the user 600. Thus, a tensile force in such a direction indicated by the vector 621 as to make the user 600 away from the obstacle 602 (area of interest) is generated in a vibration pattern of the illusionary tactile force sense to be perceived by the user 600. The intensity (strength) of the tension vibration at this time is controlled so that the closer the user 600 and the obstacle 602 (area of interest), the stronger the force is felt.

Furthermore, FIG. 6B shows the state where the obstacle 603 is located in the range 631. At this time, it can be seen that the user 600 is in imminent risk because the distance between the user 600 and the obstacle 603 is shorter than the distance between the user 600 and the obstacle 602 shown in FIG. 6A. For this reason, tactile force sense vibrations that feel stronger tension occur even if such a tensile direction as to pull the user 600 away from the obstacle 603 (area of interest) is the same. Also, the illusionary tactile force sense unit 111 may detect a change in the orientation of the user 600, and the intensity of the vibration (intensity of the force due to the vibration) is controlled on the basis of the speed of the motion of the user 600. For example, the faster the motion of the user 600 is, the greater the degree of risk to arise to the user 600 at the time of contact with an obstacle. For this reason, the illusionary tactile force sense unit 111 may control the vibration so as to apply a stronger pulling force to the user 600 as the user 600 moves faster.

On the other hand, FIG. 6C shows the state in which the user 600 has moved forward and the user 600 has approached the obstacle 601 within the visual field range 612. The obstacle 601 is present within the visual field range 612 of the user 600. For this reason, in this case, the warning system 1 is not necessarily required to cause the illusionary tactile force sense vibrations in response to the warning, and visual warning is also possible. For this reason, the warning system 1 can perform other types of warning that the user 600 has previously set. For example, the warning system 1 projects a virtual object indicating the obstacle 601 to perform such warning to prevent reduction of immersiveness with respect to the image of the virtual space being viewed by the user 600. Thus, the warning system 1 can perform various warnings for an obstacle within the visual field range 612 of the user 600.

Further, there is also a personal difference in the sense of distance corresponding to the strength of tension. For this reason, calibration may be performed in advance to determine the tensile strength and direction corresponding to the position of the space.

Also, in tactile force sense vibration, it is possible to feel the direction and the strength of pulling, so that not only when the area of interest is located outside the visual field range of the user, but also when the area of interest is located within the visual field range, warning by a tactile force sense vibration pattern may be performed. In particular, when the user is not focused on an image in the visual field range, it may be difficult for the user to notice the risk of contact even if a virtual object indicating an obstacle is displayed. Also in that case, the risk of contact can be grasped even by a user who is distracted in attention by the warning by the tactile force sense vibration pattern.

Up to this point, a description was given to the overall processing of the warning system 1 for avoiding an obstacle according to embodiment 1. According to Embodiment 1, the warning system 1 can be achieved that can perform appropriate warning while preventing a decrease in the immersiveness due to warning for obstacle avoidance, with respect to an obstacle located outside the visual field range that a user wearing the HMD 100 cannot visually recognize. For this reason, the safety of the movement for a user who cannot directly visibly recognize the area that may not be safe can be secured.

### MODIFIED EXAMPLES

Incidentally, in Embodiment 1, a description has been given to the example in which the number of obstacles is one. However, the technology according to Embodiment 1 can be applied to the case where there are a plurality of obstacles in the real space. The warning system 1 may calculate (determine) the positional relationship between each of the plurality of obstacles and the user when there are the plurality of obstacles, and may determine the area including the obstacle closest to the user (the area corresponding to the obstacle) of the plurality of obstacles as the area of interest. Then, the warning system 1 may control (change) the vibration pattern of the illusionary tactile force sense according to the positional relationship between the area of interest and the user. The warning system 1 can perform warning by the illusionary tactile force sense vibrations regarding the risk of contact with the obstacle closest to the user. Thus, the user can avoid the contact.

Also, the visual field range of the user includes a first range (e.g., the central visual field of the user) that the user easily visually recognize, and a second range (e.g., user's peripheral field of view) that is more difficult to visually recognize than the first range. Thus, the warning system 1 (the illusionary tactile force sense unit 111) may vary in the vibration pattern (strength of vibration) between the case where the area of interest is located in the first range and the case where it is located in the second range. For example, when the area of interest is located in the first range, the illusionary tactile force sense unit 111 makes vibration weaker than when the area of interest is located in the second range, because it is highly probable that the user can grasp the contact with an obstacle by display of the object.

Also, the warning system 1 may vary in the vibration pattern (such as the strength of vibration) of the illusionary tactile force sense between the case where the area of interest is located within the user's visual field range and the case where the area of interest is not located within the user's visual field range for generating the illusionary tactile force sense vibration even when the area of interest is located within the user's visual field range. For example, the warning system 1 makes the strength of the illusionary tactile force sense vibration weaker when the area of interest is located within the visual field range of the user, as compared with the case where the area of interest is located outside the visual field range of the user. By achieving such an illusionary tactile force sense vibration pattern, even when the user may overlook the virtual object in the case where the area of interest is located within the visual field range of the user, the user can be allowed to grasp the risk of contact by the illusionary tactile force sense vibration. Also, by weakening the strength of the illusionary tactile force sense vibration, it is easy to prevent a decrease in the immersiveness regarding the image of the virtual space. In this way, the warning system 1 uses the illusionary tactile force sense vibrations for warning, and thereby can perform warning not only by one type but also by a plurality of types of methods at the same time.

In Embodiment 1, the warning system 1 includes a sensor for detecting the motion of a user, and a sensor for generating illusionary tactile force sense vibrations mounted on the HMD 100. On the other hand, further, when the accuracy of the detection of the motion of a user can be increased, it is possible to more accurately identify the direction of avoidance of the user from an obstacle. For example, separately from the HMD 100, a sensor (an acceleration sensor, a gyrosensor, a depth sensor, or a GPS) for detecting the motion information, and a wearable device that generates an illusionary tactile force sense vibrations may be mounted at the segment such as the right wrist or the left wrist of the user. Further, using a motion sensor mounted on the controller, estimation of the three-dimensional orientation of a user may be performed. According to these configurations, warning in accordance with the detailed motion of the user becomes possible. In particular, the wearable device can also be freely attached to a segment that does not interfere with the motion of a user (such as a segment in the vicinity of the joint of the human body).

Incidentally, the methods for identifying the segment to which the wearable device is attached include various methods. Examples of the method for identifying a wearable device mounted segment includes a method for identifying a mounted segment on the basis of the image data obtained by photographing the wearable device mounted on a user by a camera, and a method for previously setting the segment to which the wearable device is mounted. Further, the method for identifying the wearable device mounted segment includes a method for identifying the mounted segment by comparing “the pre-recorded acceleration, speed magnitude, or the like of each segment of the user” with “the motion of the wearable device”.

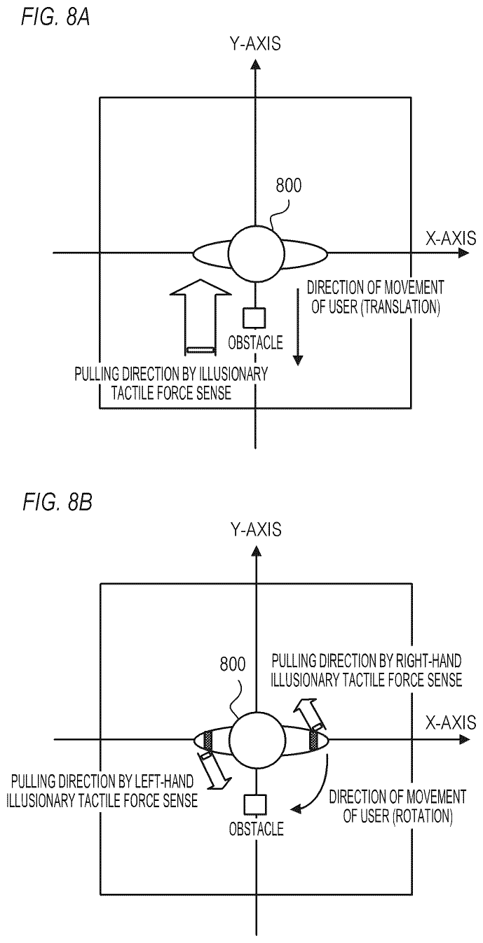

Incidentally, the sensor attached to the HMD 100 can detect only a simple motion such as translation as shown in FIG. 8A. However, when the motion of each segment of the user can be detected by an acceleration sensor, a gyrosensor, or the like, the acceleration or the like of each segment of the body of the user who wears a plurality of wearable devices can be detected. This enables the detection of not only translation but also the local motion of the user's hand, the motion such as the rotation of the body, and the like, as shown in FIG. 8B. As a result, the warning system 1 can generate illusionary tactile force sense vibrations that can sense more appropriate directions to avoid the contact between the user and the obstacle. For this reason, the warning system 1 can pull the user's body in a proper direction for each segment and can guide the user so as to move in a safe direction.

Incidentally, although the above description has been directed to the case where the user viewing the image of the virtual space is notified of the risk of contact with an obstacle by the illusionary tactile force sense vibration, notification by the illusionary tactile force sense vibration may be made in other cases. For example, also when an obstacle outside the visual field range of the user approaches the user while the user is wearing the spectacles and sending daily life, the warning system may notify the user of the risk of contact with the obstacle by the illusionary tactile force sense vibrations of the spectacles. Further, also when an obstacle approaches the user with the visually impaired person wearing a specific device (haptics device), the warning system may notify the user of the risk of contact with the obstacle by illusionary tactile force sense vibrations of the specific device. Incidentally, the visual field range of the visually impaired person is limited to 0 or a smaller range. For this reason, the notification by the illusionary tactile force sense vibration may be performed so long as the distance between the user and the area of interest is shorter than a predetermined distance regardless of whether the area of interest (obstacle) is located within the visual field range, or not.

In addition, in the above description, the expression “in a case where A is equal to or larger than B, the process goes to the step S1, and in a case where A is smaller than (lower than) B, the process goes to the step S2” may be replaced with the expression “in a case where A is greater (higher) than B, the process goes to the step S1, and in a case where A is equal to or smaller than B, the process goes to the step S2”. Conversely, the expression “in a case where A is greater (higher) than B, the process goes to step S1, and in a case where A is equal to or smaller than B, the process goes to the step S2” may be replaced with the expression “in a case where A is equal to or larger than B, the process goes to the step S1, and in a case where A is smaller than (lower than) B, the process goes to the step S2”. For this reason, unless contradiction is caused, the expression “equal to or larger than A” may be replaced with “larger (higher; longer; or more) than A”, and the expression “equal to or smaller than A” may be replaced with “smaller (lower, shorter, or less) than A”. Then, the expression “larger (higher, longer, or more) than A” may be replaced with the expression “equal to or larger than A”, and the expression “smaller (lower; shorter; or less) than A” may be replaced with the expression “equal to or smaller than A”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to ensure the safety for a user who cannot directly visually recognize an area that may not be safe.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-106720, filed Jul. 2, 2024, which is hereby incorporated by reference herein in its entirety.

What is claimed is:

1. A warning system comprising:
one or more processors configured to:
execute area detection processing of detecting an area of interest that is potentially unsafe for a user in a real space;
execute distance determination processing of determining a distance between the user and the area of interest; and
execute vibration generation processing of generating vibration that causes the user to sense a force in a direction away from the area of interest on a basis of a positional relationship between the user and the area of interest in a case where determination is made that the distance between the user and the area of interest is less than a threshold value.

2. The warning system according to claim 1, wherein, in the vibration generation processing, in a case where the vibration causing the user to sense the force in the direction away from the area of interest is generated, a vibration is generated on a basis of a direction in which the area of interest exists with reference to the user and the distance from the user to the area of interest.

3. The warning system according to claim 1, wherein, in the area detection processing, an area including at least any of an area outside a specific area set by the user, a preset object in the specific area, a person different from the user in the specific area, and an object moving in the specific area is detected as the area of interest.

4. The warning system according to claim 1, wherein, in the vibration generation processing, in a case where the vibration causing the user to sense the force in the direction away from the area of interest is generated, a change in orientation of the user is detected, and an intensity of the vibration is controlled on a basis of a speed of a motion of the user.

5. The warning system according to claim 1, wherein, in the vibration generation processing, in a case where the vibration causing the user to sense the force in the direction away from the area of interest is generated, a more intense vibration is generated in accordance with a decrease in the distance between the user and the area of interest.

6. The warning system according to claim 1, wherein, in the area detection processing, a positional relationship between each of a plurality of obstacles in a real space and the user is determined, and an area corresponding to the obstacle closest to the user is detected as the area of interest.

7. The warning system according to claim 1, wherein the one or more processors further execute determination processing of determining whether or not the area of interest is included in a visual field range of the user, and
in the vibration generation processing, in a first case where determination is made that the visual field range of the user does not include the area of interest, and determination is made that the distance between the user and the area of interest is less than the threshold value, a vibration that causes the user to sense the force in the direction away from the area of interest is generated.

8. The warning system according to claim 7, wherein
the user wears a display device on a head; and
the visual field range is a range of a central visual field in a case where the user does not wear the display device on the head.

9. The warning system according to claim 7, wherein, in the vibration generation processing, in a second case where the visual field range of the user includes the area of interest and determination is made that the distance between the user and the area of interest is less than the threshold value, a vibration that causes the user to sense the force in the direction away from the area of interest is not generated.

10. The warning system according to claim 9, wherein the one or more processors further execute display processing of displaying an image of a virtual space, wherein
in the display processing, in the second case, an image in which an object is arranged at a position in the virtual space corresponding to a position of the area of interest is displayed.

11. The warning system according to claim 7, wherein, in the vibration generation processing, the vibration that causes the user to sense the force in a direction away from the area of interest is generated even in a second case where the area of interest is included in the visual field range of the user and determination is made that the distance between the user and the area of interest is less than the threshold value.

12. The warning system according to claim 11, wherein, in the vibration generation processing, an intensity of the vibration to be generated is varied between the first case and the second case.

13. The warning system according to claim 11, wherein
the visual field range includes a first area and a second area that is more difficult for the user to visually recognize than the first area, and
in the vibration generation processing, in the second case, an intensity of the vibration to be generated is varied between a case where the area of interest is located in the first area and a case where the area of interest is located in the second area.

14. The warning system according to claim 1, comprising a head-mounted display and a controller, and
the vibration generation processing is executed in at least any of the head-mounted display, the controller, and a wearable device attached on the user.

15. A warning method comprising:
detecting an area of interest that is potentially unsafe for a user in a real space;
determining a distance between the user and the area of interest; and
generating vibration that causes the user to sense a force in a direction away from the area of interest on a basis of a positional relationship between the user and the area of interest in a case where determination is made that the distance between the user and the area of interest is less than a threshold value.

16. A non-transitory computer readable medium that stores a program, wherein the program causes a computer to execute a warning method comprising:
detecting an area of interest that is potentially unsafe for a user in a real space;
determining a distance between the user and the area of interest; and
generating vibration that causes the user to sense a force in a direction away from the area of interest on a basis of a positional relationship between the user and the area of interest in a case where determination is made that the distance between the user and the area of interest is less than a threshold value.
